(19) United States
(12) Patent Application Publication
(10) Pub. No.: US 2007/0295299 A1
(43) Pub. Date: Dec. 27, 2007

(54) Piston for a combustion engine

(75) Inventors: Michael T. Lapp, Bloomfield, MI (US); Valerian Ioja, Windsor (CA); Grace Zhao, Novi, MI (US)

Correspondence Address: WILLIAM COLLARD;COLLARD & ROE, P.C., 1077 NORTHERN BOULEVARD, ROSLYN, NY, 11576, US

(73) Assignees: Mahle Technology, Inc.; MAHLE International GmbH

(21) Appl. No.: 11/803,941

(22) Filed: May 16, 2007

Related U.S. Application Data
(63) Continuation-in-part of application No. 11/451,257, filed on Jun. 12, 2006.

(51) Int. Cl. F02F 3/00

(52) U.S. Cl. 123/193.6

(57) ABSTRACT

A piston for a combustion engine has a basic element and a ring carrier element held on the basic element with a top land all around its circumference and a ring belt all around its circumference. The ring carrier element grips around the basic element at least partially and is held on the basic element by a press fit.

### CROSS-REFERENCE TO RELATED APPLICATIONS

This is a Continuation-In-Part of U.S. patent application Ser. No. 11/451,257, filed on Jun. 12, 2006.

### BACKGROUND OF THE INVENTION

The present invention relates to a piston for a combustion engine having a basic element and a ring carrier element held on the basic element with a top land all around its circumference and a ring belt all around its circumference.

A generic piston is known from DE 103 40 292 A1. This piston comprises a basic element and a ring carrier element bolted to the basic element, said elements forming a cooling channel. A weld is provided as an additional safeguard between the basic element and the ring carrier element. This piston is also known by the name “Monotherm® ”piston.

In diesel engines in particular, pistons are subject to high thermal and mechanical loads. It is therefore desirable to provide the piston with a good cooling system, i.e. with a cooling channel of the largest possible volume, and with a connection between the basic element and the ring carrier element that can withstand particularly high mechanical loads. At the same time, the piston should be built lightweight and compact. In particular, the compression height should not be too great, in order to keep the cylinder block of the diesel engine as low as possible.

The bolted connection in the generic piston requires however that the ring carrier element has a considerable minimum height and minimum thickness so that it can accommodate a thread with a number of sufficiently deep turns necessary for a strong bolted connection. The generic piston is therefore comparatively heavy with a relatively high compression height. Since the ring carrier element needs a considerable minimum thickness, the volume of the cooling channel is also comparatively low.

### SUMMARY OF THE INVENTION

The object of the present invention is to provide a piston having a basic element and a ring carrier element held on the basic element, said piston being distinguished by a stable and strong connection between the basic element and the ring carrier element with a reduced compression height and reduced weight.

The solution comprises a piston in which the ring carrier element grips around the basic element at least partially and is held on the basic element by means of a press fit.

With the piston according to invention, therefore, the bolted connection between basic element and ring carrier element is dispensed with. The ring carrier element can therefore be designed with lower height and thickness. The stable connection between the basic element and the ring carrier element is assured by a press fit that withstands even the increased loads in a diesel engine. Since the ring carrier element is designed considerably less solid than previously, the weight of the piston in accordance with the invention is reduced. In addition, the surface and the volume of the cooling channel can be considerably greater than before, so that the cooling of the piston in accordance with the invention is considerably improved. Due to the lower design height of the ring carrier element, the compression height of the piston in accordance with the invention is reduced, so that the cylinder block of the associated combustion engine can be correspondingly reduced in height. The piston according to the invention can be manufactured more economically and at lower cost overall.

In a first embodiment of the piston according to the invention, the piston has a piston crown with an inner area formed by the basic element and having an all-round shoulder and with an outer area formed by the ring carrier element and annularly surrounding said inner area, and in that the ring carrier element grips around the all-around shoulder in the radial direction. In this area, in which the ring carrier element grips around the all-around shoulder, i.e. the basic element, the ring carrier element is held on the basic element with a press fit. Since the press fit represents a particularly strong connection between the basic element and the ring carrier element, the latter can be designed particularly low and thin-walled, without weakening the connection between basic element and ring carrier element.

It is of course also possible to additionally provide a weld between the all-round shoulder and the ring carrier element.

The piston crown can be provided in a manner known per se with a combustion bowl designed to suit the engine design.

In a second embodiment of the piston according to the invention, the piston has a piston crown formed by the ring carrier element, and the basic element is provided with an annular collar aligned axially and facing the ring carrier element, and the ring carrier element grips around the annular collar. This embodiment has, in addition to the advantages already set forth, the additional advantage that the ring belt of the ring carrier element is additionally supported by the collar. As a result, the ring belt is additionally stabilized against the loads occurring during engine operation. In particular, both the deformation of the annular grooves and the deformation of the ring belt are considerably reduced overall.

If an additional strengthening of the connection between ring carrier element and basic element is required, the ring carrier element can be provided with a recess facing the basic element, and the basic element with a raised area facing the ring carrier element. During assembly of the ring carrier element and basic element, the recess and the raised area engage and are likewise held by a press fit.

A further additional strengthening of the connection between ring carrier element and basic element is provided by an axial oriented thread arranged between the ring carrier element and the annular collar of the basic element.

If required, the ring carrier element can have at least one all-around contact surface facing the basic element, and the basic element can have at least one all-round support surface corresponding to the at least one contact surface and facing the ring carrier element, so that the ring carrier element is supported on the basic element after assembly.

In this embodiment too, the piston crown can be provided in a known manner with a combustion bowl designed to suit the engine design.

The basic element and the ring carrier element can be manufactured from different materials depending on the requirements of the particular application. The basic element can for example be made from a light metal material or from a steel material, and the ring carrier element from a steel material which is particularly thermally stable.

### BRIEF DESCRIPTION OF THE DRAWINGS

Embodiments of the invention are described in detail below on the basis of the enclosed drawings. The drawings are schematic and not true to scale.

FIG. 1 shows a first embodiment of a piston in accordance with the invention in section;

FIG. 2 shows a section along the line II-II in FIG. 1;

FIG. 3 shows a further embodiment of a piston in accordance with the invention in section;

FIG. 4 shows a section along the line IV-IV in FIG. 3;

FIG. 5 shows a further embodiment of a piston in accordance with the invention in section.

### DETAILED DESCRIPTION OF THE EMBODIMENTS

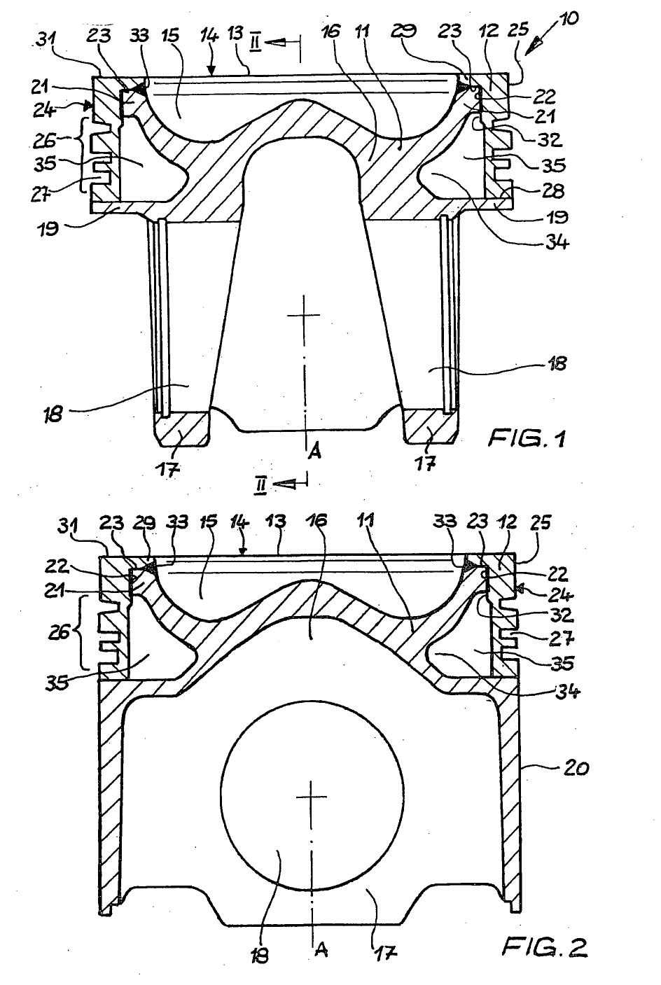

FIGS. 1 and 2 show a first embodiment of a piston 10 in accordance with the invention. The piston 10 has a basic element 11 made of a forged or sintered metallic material and a ring carrier element 12 made of a metallic material, for example a temperature-resistant steel. The basic element 11 has a piston skirt 20 and the central or inner area 13 of a piston crown 14 that is provided in a manner known per se with a combustion bowl 15. Boss connections are provided underneath the piston crown 14 and merge into bosses 17 running parallel to a longitudinal axis A of the piston 10. The bosses 17 are provided with boss holes 18 for admitting a piston pin, not shown.

In the area of the boss connections 16, an all-around flange 19 projecting radially outwards is provided. The combustion bowl 15 is limited by an all-round annular shoulder 21. The shoulder 21 has a lateral surface 22 parallel to the longitudinal axis A of the piston 10 and an end face 23 at right angles to it.

The ring carrier element 12 has an all-around and substantially cylindrical ring element 24 with an inner wall 32 which is provided in a manner known per se on its lateral surface. It has a top land 25 and a ring belt 26 with several annular grooves 27 for receiving piston rings, not shown. The lower free end of the ring element 24 forms a contact surface 28 resting on the flange 19 of the basic element 11.

The ring element 24 has in the area of the shoulder of the basic element 11 an all-around edge 29 extending radially inwards of which the surface forms the outer annular area 31 of the piston crown 14, which surrounds the central area 13 of the piston crown 14 formed by the basic element 11. The ring element 24 and the edge 29 enclose the lateral surface 22 or the end face 23 of the shoulder 21 of the basic element 11 and are so dimensioned that a press fit of the ring carrier element 12 on the basic element 11 is constituted. For assembly, the metallic ring carrier element 12 is therefore heated and mounted on the basic element 11 in the manner shown in FIGS. 1 and 2. When it cools, the ring carrier element 12 contracts, forming the press fit as described.

As an additional safeguard, a weld 33 can also be provided between the edge 29 of the ring carrier element 12 and the end face 23 of the shoulder 21 of the basic element 11, as shown by example in FIGS. 1 and 2.

The inner wall 32 of the ring element 24 and an all-around recess 34 provided underneath the combustion bowl 15 in the basic element 11 form a cooling channel 35. Thanks to the slender design of the ring carrier element 12, the cooling channel 35 has a particularly large volume and extends from the shoulder 21 to the flange 19 of the basic element 11.

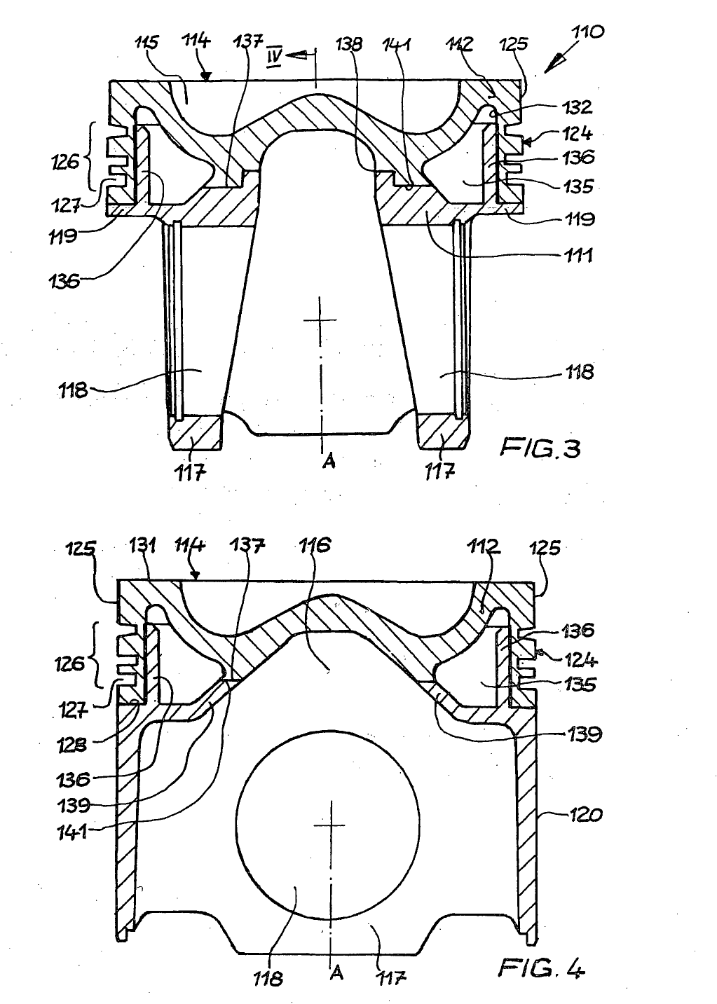

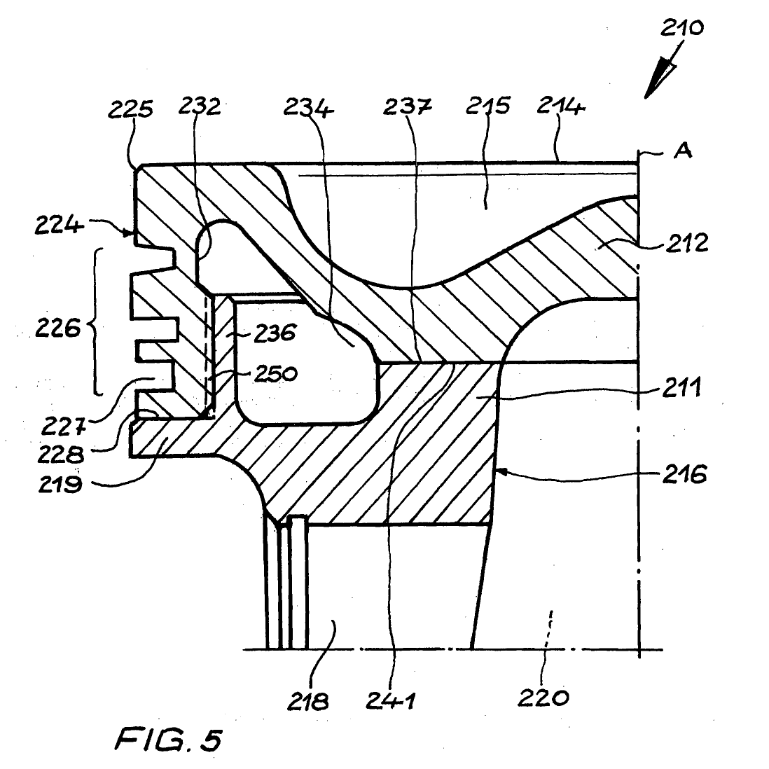

FIGS. 3 and 4 show a further embodiment of a piston 110 in accordance with the invention. The piston 110 has a basic element 111 made of a forged or sintered metallic material and a ring carrier element 112 made of a metallic material, for example a temperature-resistant steel. The basic element 111 has a piston skirt 120 and boss connections 116 merging into bosses 117 running parallel to a longitudinal axis A of the piston 110. The bosses are provided with boss holes 118 for admitting a piston pin, not shown. In the area of the boss connections 116, an all-around flange 119 projecting radially outwards is provided. An axially aligned annular collar 136 is provided in the area of the flange 119.

The ring carrier element 112 has a piston crown 114 provided in a manner known per se with a combustion bowl 115. The piston crown 114 is limited by an all-around and substantially cylindrical ring element 124 with an inner wall 132. The ring element 124 is provided on its lateral surface in a manner known per se with a top land 125 and a ring belt 126 with several annular grooves 127 for receiving piston rings, not shown. The lower free end of the ring element 124 forms a contact surface 128 resting on the flange 119 of the basic element 111.

The ring carrier element 112 has underneath the combustion bowl an annular contact surface 137 facing the basic element 111 and provided in some areas with a recess 138. The basic element 111 has accordingly a support plate 139 facing the ring carrier element 112 and provided with an annular support surface 141 corresponding to the contact surface 137. The support surface 141 has in some areas a raised area 142 corresponding to the recess 138.

In the assembled state, the inner wall 132 of the ring element 124 encloses the annular collar 136 of the basic element 111, and the raised area 142 of the basic element 111 engages in the recess 138 of the ring carrier element 112, as shown in FIG. 3. The inner wall 132, the collar 136, the raised area 142 and the recess 138 are dimensioned such that a press fit of the ring carrier element 112 on the basic element 111 is constituted.

For assembly, the metallic ring carrier element 112 is therefore heated and mounted on the basic element 111 in the manner shown in FIGS. 3 and 4. When it cools, the ring carrier element 112 contracts, forming the press fit as described.

The inner wall 132 of the ring element 124, the collar 136, an all-around recess 134 provided underneath the combustion bowl 115 in the ring carrier element 112 and the support plate 139 form a cooling channel 135. Thanks to the slender design of the ring carrier element 112, the cooling channel 135 has a particularly large volume and extends from the underside of the piston crown 114 to the flange 119 of the basic element 111.

FIG. 5 shows a further embodiment of a piston 210 in accordance with the invention. The piston 210 has a basic element 211 made of a forged or sintered metallic material and a ring carrier element 212 made of a metallic material, for example a temperature-resistant steel. The basic element 211 has a piston skirt 220 and boss connections 216 merging into bosses running parallel to a longitudinal axis A of the piston 210, not shown. The bosses are provided with boss holes 218 for admitting a piston pin, not shown. In the area of the boss connections 216, an all-around flange 219 projecting radially outwards is provided. An axially aligned annular collar 236 is provided in the area of the flange 219.

The ring carrier element 212 has a piston crown 214 provided in a manner known per se with a combustion bowl 215. The piston crown 214 is limited by an all-around and substantially cylindrical ring element 224 with an inner wall 232. The ring element 224 is provided on its lateral surface in a manner known per se with a top land 225 and a ring belt 226 with several annular grooves 227 for receiving piston rings, not shown. The lower free end of the ring element 224 forms a contact surface 228 resting on the flange 219 of the basic element 211.

An axial oriented thread 250 is arranged between the ring carrier element 212 and the annular collar 236 of the basic element 211. In the embodiment shown in FIG. 5, the thread 250 is arranged between the inner wall 232 of the ring element 224 and an outer surface of the annular collar 236.

The ring carrier element 212 has underneath the combustion bowl 215 an annular contact surface 237 facing the basic element 211. The annular contact surface 237 may be provided in some areas with a recess, not shown. The basic element 211 is provided accordingly with an annular support surface 241 facing the ring carrier element 212 and corresponding to the contact surface 237. The support surface 241 may have in some areas a raised area corresponding to said recess, not shown.

In the assembled state, the inner wall 232 of the ring element 224 encloses the annular collar 236 of the basic element 211. The contact surface 228 of the ring element 224 is in close contact to the surface of the flange 219 of the basic element 211, and the contact surface 237 of the ring carrier element 212 is in close contact to the support surface 241 of the basic element 211. The inner wall 232, the collar 236, the flange 219 and the surfaces 228, 237, 241 are dimensioned such that a press fit of the ring carrier element 212 on the basic element 211 is constituted. The press fit on one hand and the close contact between the contact surface 228 and the surface of the flange 219 as well as the close contact between the contact surface 237 and the support surface 241 is improved and supported by the thread 250. Particularly, an additional, axially effective press fit is constituted by the thread 250. Said axially effective press fit especially increases the close contact between the contact surface 228 and the surface of the flange 219 as well as the close contact between the contact surface 237 and the support surface 241.

For assembly, the metallic ring carrier element 212 is therefore heated and mounted on the basic element 211 in the manner shown in FIG. 5. When it cools, the ring carrier element 212 contracts, forming the press fit as described.

The inner wall 232 of the ring element 224, the collar 236, an all-around recess 234 provided underneath the combustion bowl 215 in the ring carrier element 212 form a cooling channel 235. Thanks to the slender design of the ring carrier element 212, the cooling channel 235 has a particularly large volume and extends from the underside of the piston crown 214 to the flange 219 of the basic element 211.

Accordingly, while only a few embodiments have been shown and described, it is obvious that many changes and modifications may be made thereunto without departing from the spirit and scope of the invention.

What is claimed is:

1. A piston for a combustion engine, comprising:
a basic element; and
a ring carrier element held on the basic element, said ring carrier element having a top land and a ring belt all around its circumference;
wherein the ring carrier element grips around the basic element at least partially and is held on the basic element by means of a press fit.

2. A piston according to claim 1, wherein the piston has a piston crown with an inner area formed by the basic element, said piston crown having an all-around shoulder and an outer area formed by the ring carrier element and annularly surrounding said inner area, and wherein the ring carrier element grips around the all-round shoulder in a radial direction.

3. A piston according to claim 2, wherein a weld is provided between the all-around shoulder and the ring carrier element.

4. A piston according to claim 2, wherein the piston crown has a combustion bowl.

5. A piston according to claim 1, wherein the basic element and the ring carrier element enclose an all-around cooling channel.

6. A piston according to claim 1, wherein the piston has a piston crown formed by the ring carrier element, wherein the basic element is provided with an annular collar aligned axially and facing the ring carrier element, and wherein the ring carrier element grips around the annular collar.

7. A piston according to claim 6, wherein the ring carrier element has at least one all-around contact surface facing the basic element, and wherein the basic element has at least one all-round support surface corresponding to the at least one all-around contact surface and facing the ring carrier element.

8. A piston according to claim 6, wherein the ring carrier element has a recess facing the basic element, wherein the basic element has a raised area facing the ring carrier element, and wherein the recess and the raised area engage by means of a press fit.

9. A piston according to claim 6, wherein the piston crown has a combustion bowl.

10. A piston according to claim 6, wherein the basic element and the ring carrier element enclose an all-around cooling channel, and wherein the annular collar forms a partial wall means of said cooling channel.

11. A piston according to claim 6, wherein an axial oriented thread is arranged between the ring carrier element and the annular collar of the basic element.

12. A piston according to claim 11, wherein the ring carrier element has at least one all-around contact surface facing the basic element and wherein the basic element has at least one all-around support surface corresponding to the at least one contact surface and facing the ring carrier element.

13. A piston according to claim 11, wherein the piston crown has a combustion bowl.

14. A piston according to claim 11, wherein the basic element and the ring carrier element enclose an all-around cooling channel and wherein the annular collar forms a partial wall means of said cooling channel.

15. A piston according to claim 1, wherein the basic element comprises a light metal material or a steel material, and the ring carrier element comprises a steel material.
